(19) United States
(12) Patent Application Publication
(10) Pub. No.: US 2005/0247225 A1
(43) Pub. Date: Nov. 10, 2005

(54) Method and apparatus for producing printing forms

(75) Inventors: Peer Dilling, Friedberg (DE); Andreas Berchtold, Wessling (DE); Johann Koniger, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/121,736

(22) Filed: May 3, 2005

(30) Foreign Application Priority Data
May 5, 2004 (DE) 10 2004 022 087.5

(51) Int. Cl. B41N 3/00

(52) U.S. Cl. 101/463.1; 101/467; 101/401.1

(57) ABSTRACT

A printing image is provided on a rewritable surface of a printing form within a press. The steps of providing the image, including erasing the surface, generating the image on the surface, fixing the imaged surface, and conditioning the imaged surface, are carried out in a section-by-section manner over the entire surface, and all the steps, or sub-combinations of the steps, may be carried out in parallel. In the apparatus for producing the printing image, the devices for erasing, imaging, fixing, and conditioning may be mounted on a common platform movable along a longitudinal direction of the printing form to allow the steps to be performed in parallel.

### FIELD OF THE INVENTION

The invention relates to a method and apparatus for producing printing forms, in particular to the production of a printing form of the rewritable type.

### BACKGROUND OF THE INVENTION

During printing with a printing form, in principle a distinction is drawn between methods which operate on the one hand with a printing form that can be written once or on the other hand with a rewritable printing form. Printing methods which use rewritable printing forms are also brought together under the keyword “computer to press/direct imaging”. The invention present here relates to a method and an apparatus for producing a permanent and erasable image on such a rewritable printing form.

Under the product description “DICOweb”, the applicant markets digital presses which operate with rewritable and erasable printing forms. During the production of such printing forms, a basic printing form cylinder is preferably subjected to an erasure step and an imaging step. An erasing apparatus which can be used when erasing such a printing form is disclosed, for example, in DE 100 08 214 A1. DE 100 23 319 A1 discloses a device for imaging such printing forms. With regard to further principles of the DICOweb technology, reference can be made to “Handbuch der Printmedien” [Printing Media Manual], Helmut Kipphan, pages 674-680, 2000, Springer-Verlag.

According to the prior art, the erasure of surface of the printing form over the entire length of the printing form is carried out in one step and in a manner decoupled from the imaging. The result here is, firstly, large overall sizes for an apparatus for producing the printing forms and therefore the press, and secondly that the erasure and subsequent imaging of such a printing form takes a long time.

### BRIEF SUMMARY OF THE INVENTION

In view of the foregoing, it is an object of the present invention to prove a novel apparatus and method for producing printing forms, with the goals of reducing the overall size of the apparatus and speeding up the process of providing an image on a printing form.

This object is achieved by the apparatus and method of the invention for producing printing forms. According to the invention, the erasure of the printing form and the imaging of the form are carried out section by section along the entire printing form or the entire surface of the same. In this case, the erasure and the imaging are preferably carried out in parallel.

For this purpose, a relative movement path is preferably established between the printing form and the corresponding erasing and imaging devices in the longitudinal direction of the printing form. This makes it possible to reduce the overall size needed for the apparatus and for the implementation of the method. Presses having apparatuses of this type can accordingly be designed to be more compact overall. Moreover, the parallel execution of the erasure and imaging allows the changeover time on a press to be significantly reduced.

The imaged surface is preferably fixed and, after or before the fixing of the image on the form, conditioning of the imaged surface is carried out section by section on the entire surface of the printing form, just like the erasure, the imaging and the fixing.

According to a preferred development of the invention, for the purpose of erasing and imaging and, if appropriate, fixing and conditioning, appropriate devices are moved in the longitudinal direction of the stationary printing form, past the entire surface of the same, all the processing steps being carried out section by section on the entire surface and at least some of the processing steps being carried out in parallel.

The apparatus according to the invention for producing a permanent and erasable image on a surface of a printing form has at least one erasing device for erasing the surface and an imaging device for imaging the erased surface. The erasing device and the imaging device are constructed in such a way that the erasure and the imaging can be carried out section by section and preferably in parallel along the entire printing form or the entire surface of the same.

Preferred embodiments of the invention will be explained in greater detail below with reference to the drawing, of which:

### BRIEF DESCRIPTION OF THE DRAWINGS

FIG. 1 shows, in a schematic view, an embodiment of an apparatus according to the invention for producing printing forms during the erasure and during the imaging of a surface of a printing form; and

FIG. 2 shows the apparatus of FIG. 1 during the conditioning and during the fixing of the imaged surface of the printing form.

### DETAILED DESCRIPTION OF THE INVENTION

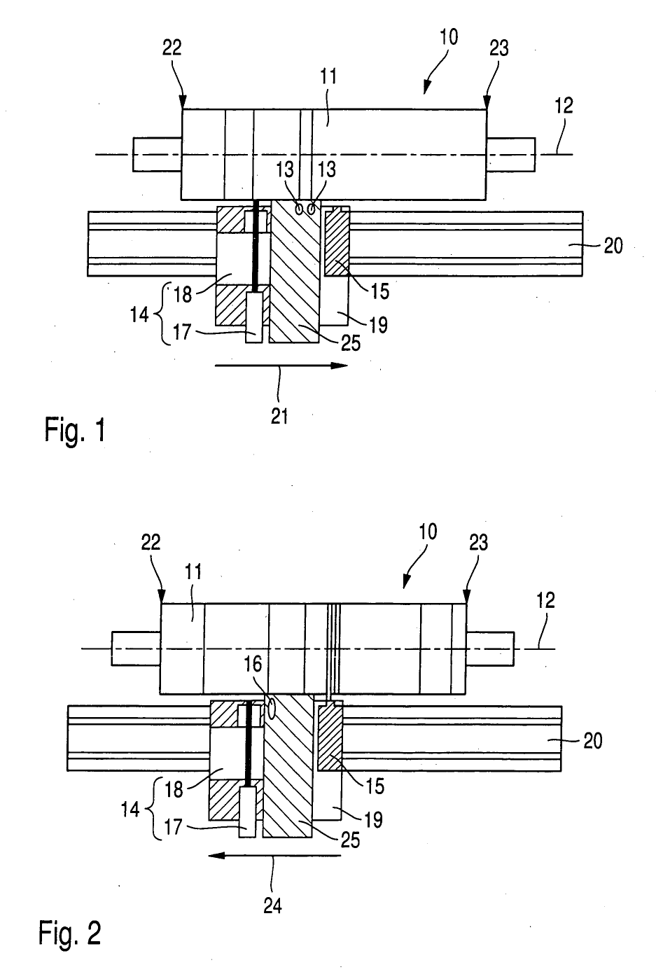

In the following text, with reference to FIGS. 1 and 2, the invention will be described by way of example for offset printing by the DICOweb technology, the offset printing variant of the DICOweb technology also being designated “DICOweb litho.”

In the method according to the invention for producing a printing form having a permanent and erasable image on a surface of a rewritable printing form, the procedure is such that a printing form 10 having a rewritable surface 11 is provided. The rewritable printing form 10 preferably has a cylindrical surface 11, a central longitudinal axis of the printing form 10 being numbered with the reference number 12 in FIG. 1. The erasure of the surface 11, imaging of the erased surface 11 and fixing and, if appropriate, conditioning of the imaged surface, are carried out in order to provide the permanent and erasable image on the surface of the printing form. As used herein, the term “permanent an erasable image” means the image is long-lasting and does not disintegrate easily by itself, yet can be removed from the surface of the printing form using a proper erasing method.

In accordance with a feature of the invention, at least the erasure and the imaging of the entire printing form 10 or the entire surface 11 of the printing form 10 are carried out in a section-by-section manner. Particularly preferably, all the method steps for producing the printing form, which include the erasure, the imaging, the fixing and the conditioning, are carried out section by section along the entire surface 11 of the printing form 10. For this purpose, a relative movement is established between appropriate devices for erasing, imaging, fixing and conditioning the printing form 10 in the direction of the central longitudinal axis 12 and therefore over the entire longitudinal direction of the same, with the erasure, the imaging, the fixing and the conditioning being carried out on the respective sections of the entire surface 11 of the printing form 10 which currently lie in the area of influence of the respective devices as the corresponding devices move past the surface.

In one embodiment illustrated in FIG. 1, an apparatus for implementing the method comprises an erasing device 13 for erasing the surface 111 of the printing form 10, an imaging device 14 for imaging the erased surface, a fixing device 15 for fixing the imaged surface and a conditioning device 16 for conditioning the imaged surface. The imaging device 14 comprises a thermal transfer ribbon 17 and a laser source 18. In the exemplary embodiment of FIGS. 1 and 2, all the devices 13, 14, 15 and 16 are fixed on a common platform 19, such that it is possible for the platform 19 together with all the devices 13, 14, 15 and 16 to be moved in the longitudinal direction along the entire printing form 10, relative to the latter, along a crossmember 20 extending parallel to the central longitudinal axis 12 of the printing form 10.

In a particularly preferred embodiment of the invention, the erasure and the imaging of the surface 11 of the printing form 10 are carried out in parallel, to be specific during the relative movement (depicted by the arrow 21 in FIG. 1) between the corresponding devices and the printing form 10. During the relative movement depicted by the arrow 21, the printing form is stationary in its longitudinal direction but rotating about its axis, and the devices 13 to 16 positioned on the platform 19 are moved across the rotating surface of the printing form 10 from a first end 22 to a second end 23 of the printing form 10. The relative movement in the sense of the arrow 21 accordingly extends over the entire length of the printing form 10.

The fixing and conditioning of the imaged surface 11 of the printing form 10 is carried out during the relative movement, depicted by the arrow 24 in FIG. 2, between the printing form 10, which is stationary in the longitudinal direction but rotating, and the moved platform 19. As can be gathered from FIG. 2, the second relative movement according to arrow 24 runs in the opposite direction to the first relative movement according to arrow 21, between the second end 23 and the first end 22 of the printing form 10 and therefore over the entire length of the same.

At this point, it should be pointed out that a “stationary” printing form in this context is understood to mean a printing form 10 of which the axial position in the direction of the central longitudinal axis 12 is unchanging, at least during the conversion of the same. A printing form 10 that is stationary in this way can nevertheless rotate about its central longitudinal axis 12 and therefore execute a rotational movement about the central longitudinal axis 12 during the erasure, imaging, conditioning and fixing of the surface 11 of the printing form 10.

In accordance with the present invention, all the sub-processes or steps of the method according to the invention, such as the erasure, imaging, conditioning and fixing, are carried out section by section on the entire surface of the printing form during a relative movement in the longitudinal direction of the printing form. In the case of producing an offset printing form, the erasure, imaging, fixing and conditioning are all carried out section by section or in a traversing manner over the entire length of the printing form 10.

In the preferred exemplary embodiment according to FIGS. 1 and 2, firstly the erasure and imaging and secondly the fixing and conditioning are carried out in parallel in one pass or in one relative movement in each case. It should be pointed out at this point that it is also possible to carry out four part steps during one relative movement in one pass.

Furthermore, it is possible to adapt the combination and, if appropriate, the order of the part steps to be carried out in parallel. For example, it is possible to carry out the erasure and imaging and/or the imaging and conditioning and/or the imaging and fixing and/or the conditioning and fixing in the longitudinal direction of the printing form in parallel on the entire surface of the printing form.

At this point, it should be pointed out that the erasing device 13 can, for example, comprise a narrow cleaning cloth 25, which is moved past the printing form 10 in the longitudinal direction of the same, with cleaning agents being supplied to the cleaning cloth 25 or to the surface 11 of the printing form 10 to be cleaned. The cleaning agent can, for example, be formed as an alkaline, water-based cleaning liquid and erase an old image from the entire surface 11 of the printing form. The image erased with the aid of the cleaning agent is picked up by the cleaning cloth. When cleaning cloth becomes soiled, it is wound up onto a dirty roll and, for the ongoing cleaning of the printing form 10, fresh cleaning cloth is unwound from a fresh cloth roll.

Instead of cleaning liquids, powdery or granular cleaning agents, cleaning gases or cleaning vapours and cleaning plasmas can also be moved in the direction of the cleaning cloth or the surface 11 of the printing form 10 from which an image is to be removed. Instead of the cleaning cloth, a brush or grinding disc can also be moved past the printing form 10.

The imaging of the erased or de-imaged surface 11 of the printing form 10 is preferably carried out by using the thermal transfer ribbon 17 shown in FIGS. 1 and 2. To that end, the thermal transfer ribbon 17 is brought into contact with the surface 11 of the printing form 10 and, by using a laser beam modulated in accordance with an image, the transfer material in the contact zone between the thermal transfer ribbon 17 and the surface 11 of the printing form 10 is applied to the printing form 10.

The fixing of the imaged surface 11 of the printing form 10 is preferably carried out thermally. In this case, for the purpose of the thermal fixing, it is possible to heat the surface 11 of the printing form 10 during the already described relative movement in the longitudinal direction of the printing form 10, for example inductively, by means of thermal radiation, by means of forced convection, or by means of laser radiation.

The conditioning of the imaged surface is carried out either after the fixing or before the fixing of the imaged surface. This includes applying a conditioning medium in the region of the imaged surface 11 of the printing form 10 for the purpose of conditioning. The conditioning medium can be supplied and caught by using the cleaning cloth 25 already mentioned. Spraying or applying the conditioning medium via a roller or brush is also possible. The choice of a suitable conditioning medium is left to those skilled in the art addressed here.

Finally, it should be pointed out once more that, according to a first partial aspect of the present invention, all the part steps for producing a permanent and erasable image on a rewritable surface of a printing form are carried out section by section along the entire surface. This is carried out by establishing a relative translational movement between the devices required for this purpose and the entire surface 11 of the printing form 10. More particularly, the devices 13 to 16 for erasing, imaging, fixing and conditioning preferably are moved translationally past the entire surface 11 of the printing form 10. In the process, the printing form 10 then executes a rotational movement about its central longitudinal axis 12. According to a second aspect of the present invention, at least some of the part steps are carried out in parallel. If the two part aspects are combined with each other, then the result is, firstly, a reduced overall size for the apparatus according to the invention and, secondly, the method according to the invention can be carried out within a short time span.

Although, with reference to FIGS. 1 and 2, the invention has been described by using the example of the production of an offset printing form, the method according to the invention can also be carried out during the production of a gravure printing form. The gravure printing alternative of the DICOweb technology is also designated “DICOweb gravure.”

In this embodiment of the method according to the invention, following the erasure and before the imaging of the surface of the gravure printing form, bowl-like depressions on the surface of the printing form are filled, preferably with the aid of a squeegee. In this embodiment of the method according to the invention, the erasure, filling and imaging of the printing form are again carried out section by section over the entire surface, a relative movement in the longitudinal direction of the printing form between the printing form and the corresponding devices for carrying out the erasure, filling and imaging again being established for this purpose. It is also possible again to carry out at least some of these part steps in parallel.

An apparatus according to the invention having the devices 13 to 20 is preferably integrated into every printing unit of a press, in the region of every rewritable printing form. Accordingly, the method is preferably carried out within the press.

1. A method for preparing a printing form within a press, comprising:
erasing a rewritable surface of the printing form section by section and along an entire surface of the printing form; and
imaging the surface of the printing form section by section and along an entire surface of the printing form to provide a permanent and erasable image on the surface of the printing form.

2. A method according to claim 1, including establishing a relative movement path of the erasing and imaging devices with respect to the printing form over the entire axial longitudinal direction of the printing form, the steps of erasing and imaging in each case being carried out on sections of the rewritable surface of the printing form as the respective erasing and imaging devices pass over the sections while moving along the relative movement path.

3. A method according to claim 1, wherein the erasing and imaging steps are carried out in parallel along the rewritable surface of the printing form.

4. A method according to claim 1, further includes steps of:
after the imaging step, fixing the imaged surface section by section on the entire imaged surface of the printing form along a relative movement path established between the printing form and a fixing device carrying out the fixing.

5. A method according to claim 4, further including the step of conditioning the imaged surface section by section on the entire surface of the printing form after the fixing or before the fixing.

6. A method according to claim 5, wherein the steps of erasing, imaging, fixing and conditioning are carried out by moving corresponding erasing, imaging, fixing and conditioning devices in a longitudinal direction of the printing form to pass the entire surface of the printing form, with the printing form being stationary in the longitudinal direction and rotating about a longitudinal axis.

7. A method according to claim 6, wherein the erasing and imaging and/or the imaging and conditioning and/or the imaging and fixing and/or the conditioning and fixing steps are carried out in parallel in the longitudinal direction of the printing form on the entire surface of the printing form.

8. A method according to claim 6, wherein the erasure, imaging, fixing and conditioning steps are carried out in parallel on the entire surface during a movement of the corresponding erasure, imaging, fixing and conditioning devices together in the longitudinal direction of the printing form.

9. A method according to claim 6, wherein the erasing and imaging steps are carried out in parallel on the entire surface during a first movement of the corresponding erasing and imaging devices in the longitudinal direction of the printing form, and the fixing and the conditioning are then carried out in parallel on the entire surface during a second movement of the corresponding fixing and conditioning devices in the longitudinal direction of the printing form.

10. A method according to claim 9, wherein the first movement and the second movement each extends over the entire length of the stationary printing form, with the second movement running in the opposite direction to the first movement.

11. A method for preparing a printing form within a press, comprising:
carrying out in parallel the following steps:
erasing a rewritable surface of the printing form;
imaging the surface of the printing form to provide a permanent and erasable image on the rewritable surface of the printing form;
fixing a portion of the imaged surface; and
conditioning a portion of the imaged surface.

12. A method according to claim 11, wherein each of the erasing, imaging, fixing and conditioning steps is carried out section by section along an entire surface of the printing form.

13. An apparatus for producing a permanent and erasable image on a rewritable surface of a printing form within a press, comprising:
an erasing device for erasing the surface of the printing form, the erasing device being constructed to erase the surface section by section along the entire surface of the printing form; and
an imaging device for imaging the erased surface, the imaging device being constructed to image the surface section by section over the entire surface of the printing form.

14. An apparatus according to claim 13, wherein the erasing device and imaging device are movable relative to the printing form over the entire surface of the printing form.

15. An apparatus according to claim 13, wherein the erasing device and imaging device are constructed to carry out in parallel the erasure and the imaging of the surface of the printing form.

16. An apparatus according to claim 13, further including a fixing device for fixing the imaged surface, the fixing device being constructed to be movable relative to the printing form to fix the imaged surface section by section along the entire surface of the printing form.

17. An apparatus according to claims 16, further including a conditioning device for conditioning the imaged surface after or before the fixing of the imaged surface, the conditioning device being constructed to be movable relative to the printing form over the entire surface of the printing form to condition the imaged surface section by section along the entire surface of the printing form.

18. An apparatus according to claim 13, wherein the erasing device, the imaging device, the fixing device and the conditioning device are constructed such that the erasure and imaging and/or the imaging and conditioning and/or the imaging and fixing and/or the conditioning and fixing are carried out in parallel.

19. An apparatus according to claim 13, wherein the erasing device, the imaging device, the fixing device, and the conditioning device are positioned on a common platform movable in a longitudinal direction of the printing form.
